(19) United States
(12) Patent Application Publication
(10) Pub. No.: US 2009/0262689 A1
(43) Pub. Date: Oct. 22, 2009

(54) METHOD AND APPARATUS FOR ALLOCATING RESOURCES TO A NODE IN AD-HOC NETWORK

(75) Inventors: Wun Cheol Jeong, Daejeon-city (KR); Nae Soo Kim, Daejeon-city (KR); Cheol Sig Pyo, Daejeon-city (KR); Jong Moon Chung, Seoul (KR); Hyung Weon Cho, Seoul (KR); Ki Yong Jin, Seoul (KR)

Correspondence Address: STAAS & HALSEY LLP, SUITE 700, 1201 NEW YORK AVENUE, N.W., WASHINGTON, DC, 20005, US

(73) Assignees: ELECTRONICS AND TELECOMMUNICATIONS RESEARCH INSTITUTE, Daejon (KR); INDUSTRY-ACADEMIC COOPERATION FOUNDATION, Seoul (KR)

(21) Appl. No.: 12/188,469

(22) Filed: Aug. 8, 2008

(30) Foreign Application Priority Data
Apr. 22, 2008 (KR) 10-2008-0037312

(51) Int. Cl. H04W 28/16

(52) U.S. Cl. 370/329

(57) ABSTRACT

A method of allocating resources to a node in an ad-hoc network includes storing a basic frame structure including a predetermined number of time slots, in which time slots to be used by the node in the ad-hoc network are arranged at predetermined positions, determining a start time slot among the predetermined number of time slots included in the basic frame structure based on a path sequence number that is a number related to a position of the node on a routing path, and determining a frame structure including the predetermined number of time slots from the start time slot in the basic frame structure that circulates as a communications frame structure for communications of the node.

### CROSS-REFERENCE TO RELATED PATENT APPLICATIONS

This application claims the benefit of Korean Patent Application No. 10-2008-0037312, filed on Apr. 22, 2008, in the Korean Intellectual Property Office, the disclosure of which is incorporated herein in its entirety by reference.

### BACKGROUND OF THE INVENTION

1. Field of the Invention

The present invention relates to the allocation of resources to nodes, particularly, to cluster heads, in an ad-hoc network that is a wireless multi-hop network, and more particularly, to a method and apparatus for allocating resources to nodes by rapidly determining a communications frame structure to use without a complicated calculating process by using only a path sequence number of each cluster head when a routing path between the cluster heads is determined after clusters are formed.

The present invention is derived from a research project supported by the Information Technology (IT) Research & Development (R&D) program of the Ministry of Information and Communication (MIC) and the Institute for Information Technology Advancement (IITA) [2005-S-106-03, Development of Sensor Tag and Sensor Node Technologies for RFID/USN].

2. Description of the Related Art

In an ad-hoc network, each of nodes that move freely shares a single medium independently, communicating in a peer-to-peer method and a multi-hop method. In this network, since many nodes share a single medium, accessing the medium by each node needs to be controlled in order to prevent collisions between the nodes. And when the node has limited energy resources, the energy consumed by the node due to the collisions makes up a large portion of the overall energy consumption of the node.

To control the collision, carrier sense multiple access with collision avoidance (CSMA/CA) and many other medium access control methods suggested by correcting CSMA/CA have been introduced. However, to solve the collision problem, since a method of random access to medium cannot be used to completely and fundamentally avoid collisions, a frame structure is introduced and a time slot is allocated to each node, thereby fundamentally avoiding the collisions.

According to this method, however, there are lots of difficulties in allocating a time slot to each node in the ad-hoc network in which constituent nodes freely move. That is, when a time slot is allocated to a particular node in order to avoid collision and the node moves and leaves an ad-hoc network to which the node currently belongs, or a new node enters the ad-hoc network, the operations of determining a frame structure to be used in the whole network and of allocating a time slot need to be performed again.

The frame structure determination and time slot allocation are performed to avoid collision between the nodes considering the interference between the nodes. This means that a process such as the time slot allocation must be performed considering the whole network. Accordingly, there is a problem in that additional resources and time is wasted due to the determining of a frame structure and allocating of a time slot according to the change of the constituent nodes in the ad-hoc network.

In addition, a method of allocating resources such as a time slot by combining the advantages of the above two methods has been suggested. However, the difficulty in allocating a time slot cannot be avoided by the method.

In the above methods of allocating a time slot to each node in the ad-hoc network, first, nodes in the ad-hoc network, which are to be considered, are recognized and at least one time slot is allocated to each node. This is achieved by modifying an algorithm that is already optimized in other fields to fit to the ad-hoc network. Nevertheless, in this method, when a node leaves or enters the ad-hoc network, the time slot needs to be reallocated to each node in the ad-hoc network.

In another method, when a node determines a time slot to use, the node notifies information on its time slot to other neighboring nodes to avoid a possible collision between the node and its neighboring nodes. Then, the other nodes determine time slots to use and distribute information about their time slots to other neighboring nodes so that resources such as the time slot are allocated. In this method, when a node transmits information about its time slot to neighboring nodes, random media access control is generally used. However, this method has a problem in that it takes a long time to completely allocate resources such as the time slot after the network is initially configured.

As a result, in the ad-hoc network configured with nodes having limited energy resources and limited processing abilities, there is a demand for technology to minimize the amount of energy consumed by each node and the configuration time of the ad-hoc network by allocating resources such as the time slot to each node as fast as possible.

### SUMMARY OF THE INVENTION

To solve the above and/or other problems regarding the allocation of resources to nodes in an ad-hoc network, the present invention provides a method and apparatus for allocating resources to nodes in the ad-hoc network by rapidly allocating resources without losses due to collisions between the nodes to minimize the amount of energy consumption and the configuration time of the ad-hoc network.

According to an aspect of the present invention, a method of allocating resources to a node in an ad-hoc network includes storing a basic frame structure including a predetermined number of time slots, in which time slots to be used by the node in the ad-hoc network are arranged at predetermined positions; determining a start time slot among the predetermined number of time slots included in the basic frame structure based on a path sequence number that is a number related to a position of the node on a routing path; and determining a frame structure including the predetermined number of time slots from the start time slot in the basic frame structure that circulates as a communications frame structure for communications of the node.

According to another aspect of the present invention, an apparatus for allocating resources to a node in an ad-hoc network includes a basic frame structure storage unit storing a basic frame structure including a predetermined number of time slots, in which time slots to be used by the node in the ad-hoc network are arranged at predetermined positions; a start time slot determination unit determining a start time slot among the predetermined number of time slots included in the basic frame structure based on a path sequence number that is a number related to a position of the node on a routing path; and a communications frame structure determination unit determining a frame structure including the predetermined number of time slots from the start time slot in the basic frame structure that circulates as a communications frame structure for communications of the node.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates types of frames needed for a cluster head according to an embodiment of the present invention;

FIG. 2A is a flowchart for explaining a method of allocating resources to a node in an ad-hoc network according to an embodiment of the present invention;

FIG. 2B is a flowchart for explaining an operation of determining a start time slot of a predetermined number of time slots included in a basic frame structure based on a path sequence number of a node, of FIG. 2A;

FIG. 3 illustrates a signal transceiving sequence between cluster heads according to an embodiment of the present invention;

FIGS. 4A and 4B illustrate communications frame structures for the cluster heads according to an embodiment of the present invention;

FIG. 5 illustrates a method of determining the communication frame structure of a cluster head according to an embodiment of the present invention;

FIG. 6 illustrates the use of a frequency at a branch according to an embodiment of the present invention; and

FIG. 7 illustrates an apparatus for allocating resources to a node in an ad-hoc network according to an embodiment of the present invention.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention. Hereinafter, a method and apparatus for allocating resources to nodes in the ad-hoc network according to an embodiment of the present invention will be described in detail by explaining exemplary embodiments thereof with reference to the attached drawings. Like reference numerals in the drawings denote like or similar constituent elements or operations in the present invention.

According to an embodiment of the present invention, first, a basic frame structure used for data transmission by a node in an ad-hoc network is defined. Then, when a node in the ad-hoc network transmits data, time slots are rapidly allocated to avoid collision with neighboring nodes.

In particular, in this method, when the node is a cluster head, the communications frame structure of the cluster head that is determined for the cluster head to communicate with other nodes is repeatedly used in other cluster heads located at intervals of a particular number of hops. According to the above method, when the cluster head determines its communications frame structure, the communications frame structures of other cluster heads separated by a one-hop distance from the cluster head in the opposite directions are automatically determined. Thus, once the cluster node knows the sequential position, which determines the ID of the communications frame structure of the cluster node, on a routing path to which the cluster node belongs, the cluster node can transmit data without a collision with other nodes occurring.

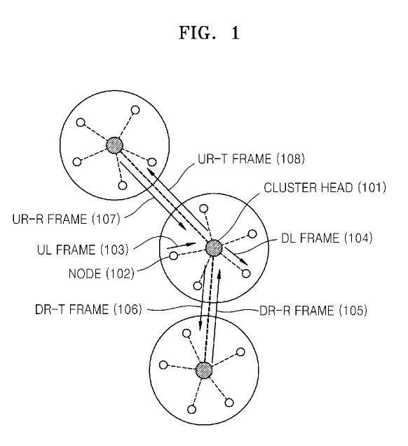

FIG. 1 illustrates types of frames needed for a cluster head according to an embodiment of the present invention. A plurality of nodes 102 constituting an ad-hoc network are first deployed and initialized to form a cluster and then a cluster head 101 capable of controlling the cluster is selected. The cluster head 101 forms a routing path 110 capable of exchanging data by communicating with other cluster heads formed around the cluster head 101.

The cluster head 101 needs at least six frames: an uplink UL frame 103 for receiving data from a child node in the cluster, a downlink DL frame 104 for transmitting data to the child node in the cluster, a down-relay receiver DR-R frame 105 for receiving data from a lower cluster head included in the routing path 110, a down-relay transmitter DR-T frame 106 for transmitting data to the lower cluster head, an up-relay receiver UR-R frame 107 for receiving data from an upper cluster head included in the routing path 110, and an up-relay transmitter UR-T frame 108 for transmitting data to the upper cluster head.

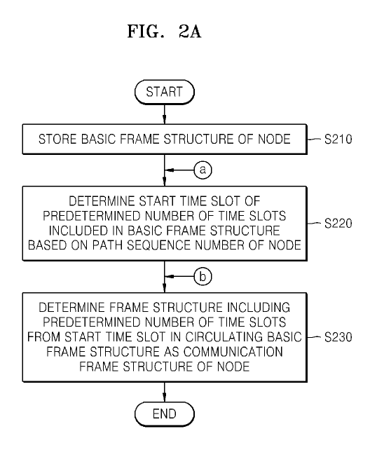

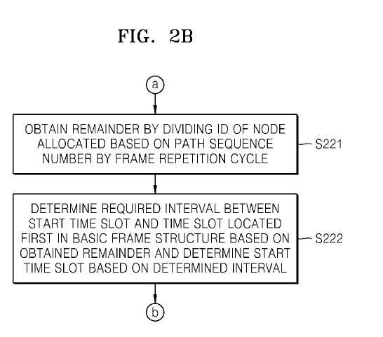

The cluster head 101 appropriately allocates time slots to the at least six frames to avoid collision with other nodes. The method of allocating resources such as the time slot is described with reference to FIGS. 2A and 2B.

FIG. 2A is a flowchart for explaining a method of allocating resources to a node in an ad-hoc network according to an embodiment of the present invention. Referring to FIG. 2A, the node in the ad-hoc network stores a basic frame structure including a predetermined number of time slots, in which time slots to be used by the node are arranged at particular positions (S210). The node in the ad-hoc network may be the cluster head of a cluster in the ad-hoc network. Hereinafter, it is assumed that the node in the ad-hoc network is the cluster head 101 having the routing path 110 of FIG. 1 and the cluster head 101 is assumed to be in the environment illustrated in FIG. 1.

The basic frame structure is not only for the cluster head 101 but also for other cluster heads belonging to the routing path 110. Thus, the basic frame structure can be said to be a frame structure that is preset for cluster heads forming the routing path. In other words, the basic frame structure is a frame structure that is preset so that each cluster head can quickly determine its communications frame structure for communications with other nodes.

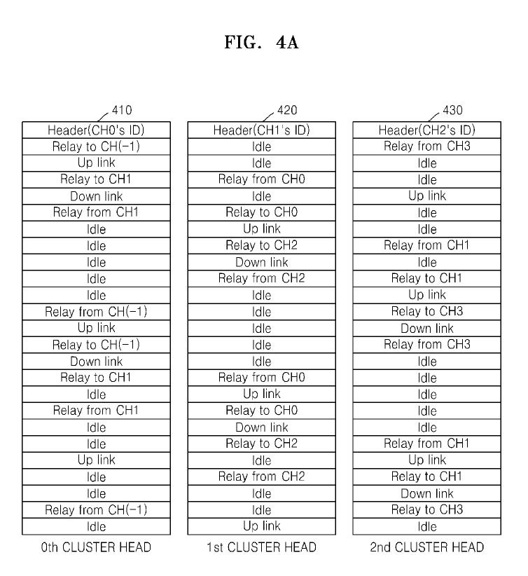

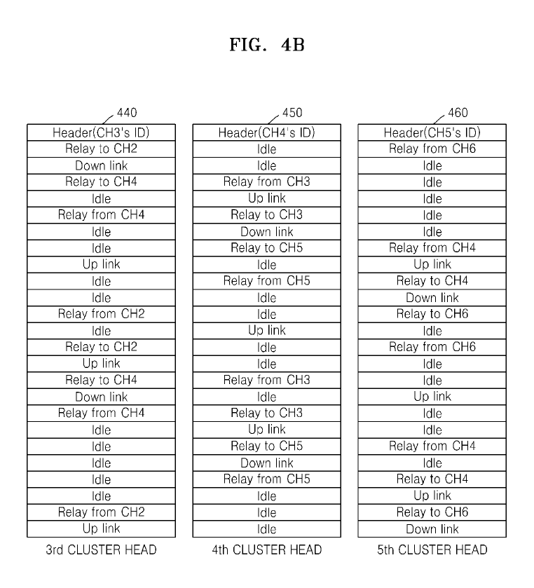

The basic frame structure is determined to prevent collisions that may be generated between the nodes included in the routing path 110 and collisions that may be generated between the nodes included in the routing path 110 and the nodes that are not recognized by the cluster head 101. The basic frame structure may be arbitrarily selected by a designer during initial network design. An example of the basic frame structure is a communications frame structure 410 of a 0^{th} cluster head shown in FIG. 4A, which will be described later.

If it is assumed that the basic frame structure is the communications frame structure 410 of the 0^{th} cluster head shown in FIG. 4A, then, the basic frame structure includes 24 time slots except for the header. The time slots corresponding to the UL frame, the DL frame, the DR-R frame, the DR-T frame, the UR-R frame, and the UR-T frame which are used by the cluster head 101 for data communications are respectively indicated as time slots of Up link, Down link, Relay from CH1, Relay to CH1, Relay from CH(−1), and Relay to CH(−1). Since the basic frame structure is predetermined, the value “a” in the time slots of Relay to/from CH(a) included in the basic frame structure may vary according to the cluster head 101. That is, when the cluster head 101 is a cluster head having an ID of 2, the value “a” may be 1or 3 instead of −1 or 1.

Next, a start time slot is determined among the predetermined number of time slots included in the basic frame structure based on a path sequence number that is a number related to the position of the cluster head 101 in the routing path (S220). The routing path for data communications sequentially includes cluster heads along the routing path. Then, the path sequence number of a particular cluster head is set according to the arrangement order of the cluster heads on the routing path.

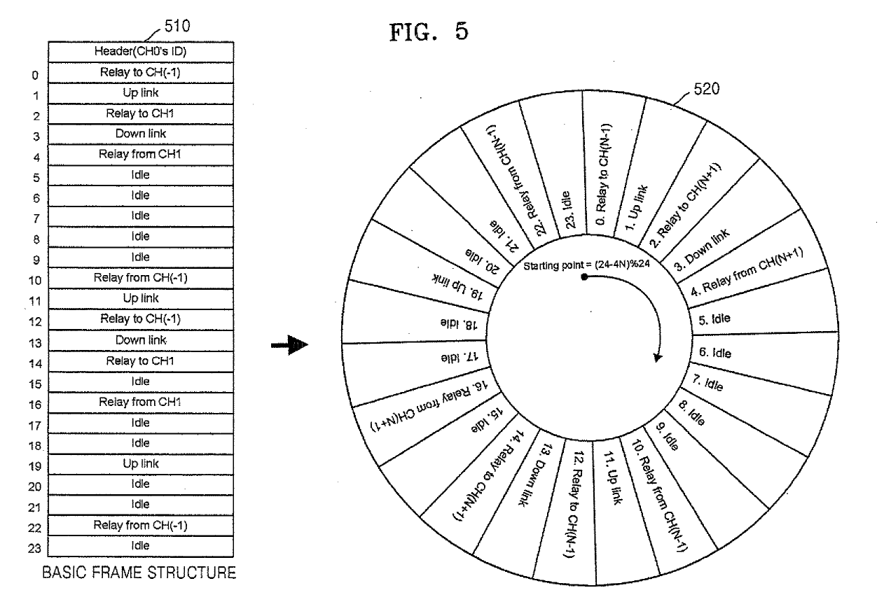

A circular frame structure may be formed by connecting the first time slot and the last time slot of the basic frame structure, which is the same as a circular frame structure 520 of FIG. 5 which will be described later. The start time slot that is a time slot located first in terms of time in the communications frame structure of the cluster head 101 is determined from the circular frame structure. The communications frame structure of the cluster head or node means a frame structure in which time slots are allocated so that the cluster head or node can communicate with other nodes without a collision occurring.

The communications frame structure of the cluster head 101 is determined to be a frame structure including the predetermined number of time slots included in the basic frame from the start time slot in the circular frame structure that is a circulating basic frame structure (S230).

FIG. 2B is a flowchart for explaining Operation S220 of FIG. 2A. Referring to FIG. 2B, the remainder is obtained by dividing the ID of the cluster head 101, allocated based on the path sequence number of the cluster head 101, by a frame repetition cycle that is a cycle of the cluster heads having the same communications frame structure on the routing path (S221).

The interval between the start time slot of the communications frame structure of the cluster head 101 and a time slot located first in the basic frame structure of the cluster head 101 is determined based on the above remainder, and the start time slot is determined based on the determined interval (S222).

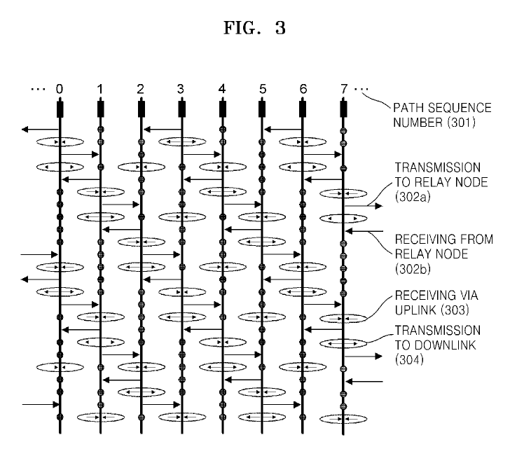

FIG. 3 illustrates a signal transceiving sequence between cluster heads according to an embodiment of the present invention. Referring to FIG. 3, a signal transceiving sequence formed based on the situation of FIG. 1 and the resources allocation method of FIG. 2 is shown. The signal transceiving sequence includes time slots corresponding to at least six frames of the UL frame 103, the DL frame 104, the DR-R frame 105, the DR-T frame 106, the UR-R frame 107, and the UR-T frame 108. Also, the signal transceiving sequence shows an example of a signal transceiving sequence generated in consideration of a problem due to a hidden node and collisions that may be generated between cluster heads forming a routing path in an ad-hoc network, in particular, an ad-hoc linear network. The hidden node problem refers to collisions that may be generated between the cluster heads included in the routing path and nodes that are not recognized by the cluster heads included in the routing path.

The signal transceiving sequence of each cluster head having a single path sequence number 301 includes a time slot for transmission 302a to a relay node and a time slot for receiving 302b from a relay node with respect to the relay node that is the upper cluster head or lower cluster head of the cluster head and a time slot for receiving 303 via an uplink and a time slot for transmission 304 via a downlink, wherein the time slots for the receiving 303 and the transmission 304 are used for data communications with child nodes in the cluster to which the cluster head belongs. The time slots for the transmission 302a to a relay node and the receiving 302b from a relay node include four types of time slots, that is, time slots for transmission to an upper cluster head of a corresponding cluster head and receiving from the upper cluster head and time slots for transmission to a lower cluster head of a corresponding cluster head and receiving from the lower cluster head.

Consequently, the signal transceiving sequence of a single cluster head includes the time slots for the receiving 303 via an uplink and transmission 304 via a downlink and the above-described four types of time slots so that six types time slots are arranged at particular positions. This arrangement prevents a cluster head from colliding with other nodes.

FIGS. 4A and 4B illustrate the communications frame structures for the cluster heads according to an embodiment of the present invention. In FIGS. 4A and 4B, “CH” denotes a cluster head. Referring to FIGS. 4A and 4B, a communications frame structure 410 of the 0^{th} cluster head, a communications frame structure 420 of the 1^{st} cluster head, a communications frame structure 430 of the 2^{nd} cluster head, a communications frame structure 440 of the 3^{rd} cluster head, a communications frame structure 450 of the 4^{th} cluster head, and a communications frame structure 460 of the 5^{th} cluster head are shown according to the transmission sequence of FIG. 3. Each of The IDs of the cluster heads, assigned with the numbers from 0 to 5, may be set to be identical to or different from the path sequence number of the corresponding cluster head.

FIG. 5 illustrates a method of determining the communication frame structure of a cluster head according to an embodiment of the present invention. Referring to FIG. 5, the circular frame structure 520 is formed by connecting the first time slot and the last time slot of the basic frame structure 510 to determine the communications frame structure of a cluster head.

Since the basic frame structure 510 for a cluster head must include time slots corresponding to the minimum number of the frames 103-108 to be transmitted/received as shown in FIG. 1, the communications frame structures of the cluster heads existing on the routing path are repeated. In other words, when all cluster heads need to have the same minimum number of the frames 103-108 in the communications frame structure of each cluster head, for example, one of the UL frame 103, one of the DL frame 104, one of the DR-R frame 105, one of the DR-T frame 106, one of the UR-R frame 107, and one of the UR-T frame 108, the orders and positions of the time slots corresponding to the frames 103-108, of which each is used for each of neighboring cluster heads, must be different from each other in order to avoid interference with each other. However, for cluster heads separated over a predetermined distance from each other, the orders and positions of the time slots corresponding to the frames 103-108 are the same. That is, since the number of time slots corresponding to the minimum frames needs to be identical in all cluster heads, cluster heads having the same communication frame structures appear at constant intervals.

This means that the number of frames to be transmitted by each cluster head without causing collision with other cluster heads or nodes is limited. Accordingly, when a cluster head on the routing path determines its communications frame structure, the communications frame structures of the cluster heads separated from the cluster head by a distance of one hop at both sides of the cluster head are automatically determined. Thus, just by knowing the path sequence number that is a number related to its position on the routing path, a cluster head can independently determine the communications frame structure that can be used to transmit data without collision.

In the determination of a communications frame structure corresponding to the signal transceiving sequence of FIG. 3, there are six different communications frame structures. When the path sequence number of each cluster head and the ID of the cluster head are correlated in an ad-hoc network, the communications frame structure owned by a certain cluster head can be determined as follows by using the calculation of the remainder.

$$N = n mod 6 , where \{ \begin{matrix}n = cluster head ID \\ 0 \leq N < 6\end{matrix}$$

This uses the fact that the six communications frame structures 410-460 of FIGS. 4A and 4B are repetitive due to the repetition of the signal transceiving sequence of FIG. 3. That is, due to the existence of the repetition, all cluster heads do not need to store the six communications frame structures 410-460 and only the communications frame structure 410 of the 0^{th} cluster head needs to be stored as the basic frame structure 510. The communications frame structure of a particular cluster head is formed by obtaining the value N by using the above equation and then sequentially connecting 24 time slots using the [(24−4×N) mod 24]^{th} time slot of the basic frame structure 510 as the start time slot in the circular frame structure 520 obtained by modifying the basic frame structure 510.

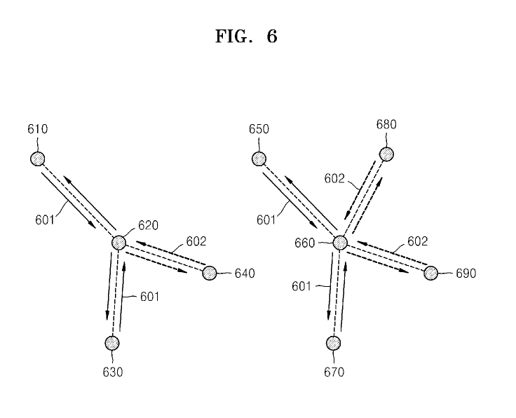

FIG. 6 illustrates the use of a frequency at a branch according to an embodiment of the present invention. FIG. 6 shows a situation in which a branch 602 is generated on an existing routing path 601. In order for a node connected via the branch to use the above-described basic frame structure and the communications frame structure, a different frequency from that used by the existing routing path 601 must be used at the branch 602.

Time slots used by a cluster head included in the existing routing path 601 include at least two lower node time slot pairs that are two time slots for exchanging data with a lower node included in the existing routing path 601 and at least two upper node time slot pairs that are two time slots for exchanging data with an upper node included in the existing routing path 601.

Accordingly, when the branch 602 is a sub path, one of the lower node time slot pairs is allocated to the branch 602. When the branch 602 is a higher path, one of the upper node time slot pairs is allocated to the branch 602. Thus, the existing cluster head can communicate through the branch 602. A node connected via the branch 602 needs to be able to use multiple frequencies and may include an additional one bit for the identification between the branch 602 and the existing routing path 601 in the DR-R frame or DR-T frame, and the UR-R frame or UR-T frame. As a result, communications at a Y-shape branch and X-shape branch as shown in FIG. 6 are made possible so that the resources allocation methods described with reference to FIGS. 1-5 can be applied to a more complicated routing path.

The structure and number of the communications frame are dependent on the initial signal transceiving sequence as shown in FIG. 3. Thus, when a different signal transceiving sequence from that of FIG. 3 is set during the initial installation of an ad-hoc network, communications frames having different structures and numbers can be created. As a result, a variety of communications frame structures can be formed according to the purpose of the ad-hoc network to be installed.

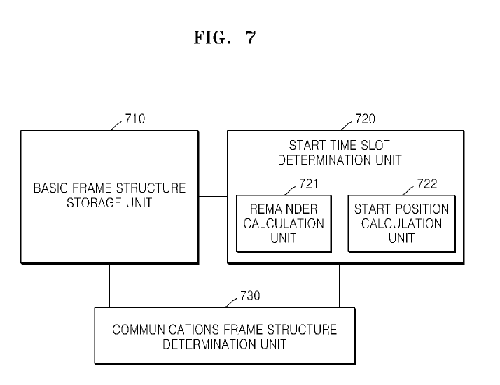

FIG. 7 illustrates an apparatus for allocating resources to a node in an ad-hoc network according to an embodiment of the present invention. For a better understanding of the detailed technical concept of FIG. 7, the descriptions with reference to FIGS. 1-6 are referred to. Referring to FIG. 7 the apparatus for allocating resources to a node in an ad-hoc network according to the present embodiment includes a basic frame structure storage unit 710, a start time slot determination unit 720, and a communications frame structure determination unit 730.

The basic frame structure storage unit 710 stores a basic frame structure including a predetermined number of time slots, in which time slots to be used by a node in the ad-hoc network are arranged at predetermined positions. The method of storing may comprise storing externally received information about the basic frame structure in a memory such as a random access memory (RAM) or previously storing information about the basic frame structure.

The start time slot determination unit 720 determines a start time slot of the predetermined number of time slots included in the basic frame structure based on the path sequence number that is a number related to a position of the node on the routing path. The start time slot determination unit 720 may include a remainder calculation unit 721 and a start position calculation unit 722.

The remainder calculation unit 721 calculates a remainder by dividing the ID of the node allocated based on the path sequence number by a frame repetition cycle that is a cycle of the nodes having the same communications frame structure on the routing path. The start position calculation unit 722 determines an interval between the start time slot and the time slot located at the first position of the basic frame structure based on the obtained remainder and then determines the start time slot based on the determined interval. The remainder calculation unit 721 or the start position calculation unit 722 may be embodied by using a processor.

The communications frame structure determination unit 730 determines the frame structure including the predetermined number of time slots from the start time slot in the basic frame structure that circulates as a communications frame structure for communications of the node.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to the above embodiment, since collisions between nodes, particularly, between cluster nodes, in the ad-hoc network, are prevented and resources such as a time slot are allocated as simply and quickly as possible, the time and the calculation amount necessary for the allocation of resources can be reduced. As a result, as the energy efficiency of the ad-hoc network is increased, the reliability of the ad-hoc network is improved.

Also, the present invention can be applied to a cluster head for which a routing path is set. Since additional resources and time used for the allocation of a time slot by the cluster head can be minimized, a faster and more efficient ad-hoc network can be implemented.

While this invention has been particularly shown and described with reference to exemplary embodiments thereof, it will be understood by those of ordinary skill in the art that various changes in form and details may be made therein without departing from the spirit and scope of the invention as defined by the appended claims.

What is claimed is:

1. A method of allocating resources to a node in an ad-hoc network, the method comprising:
storing a basic frame structure including a predetermined number of time slots, in which time slots to be used by the node in the ad-hoc network are arranged at predetermined positions;
determining a start time slot among the predetermined number of time slots included in the basic frame structure based on a path sequence number that is a number related to a position of the node on a routing path; and
determining a frame structure including the predetermined number of time slots from the start time slot in the basic frame structure that circulates as a communications frame structure for communications of the node.

2. The method of claim 1, wherein the basic frame structure is determined to prevent collisions between nodes included in the routing path and collisions between the nodes included in the routing path and a node that is not recognized by the node.

3. The method of claim 1, wherein the determining of the start time slot comprises:
obtaining a remainder by dividing an ID of the node allocated based on the path sequence number by a frame repetition cycle that is a cycle of nodes having the same communications frame structure on the routing path; and
determining an interval between the start time slot and a time slot located at the first position of the basic frame structure based on the obtained remainder and determining the start time slot based on the determined interval.

4. The method of claim 1, wherein the node is a cluster head of a cluster in the ad-hoc network.

5. The method of claim 4, wherein the basic frame structure comprises of at least the time slots each corresponding to a frame for receiving data from a child node in the cluster, a frame for transmitting data to the child node in the cluster, a frame for receiving data from a lower node included in the routing path, a frame for transmitting data to the lower node included in the routing path, a frame for receiving data from an upper node included in the routing path, and a frame for transmitting data to the upper node included in the routing path.

6. The method of claim 1, wherein, when the node has a branch, the node communicates with a node connected via the branch by using a frequency that is different from a frequency used in the routing path.

7. The method of claim 1, wherein the time slots to be used by the node include at least a two lower node time slot pair that are two time slots used in exchanging data with one or more lower nodes included in the routing path and at least a two upper node time slot pair that are two time slots for exchanging data with an upper node included in the routing path, and, when the node is located at a branching point, each of the lower node time slots will be allocated to each branch and, when the branch is a higher path, each of the upper node time slots will be allocated to each branch.

8. An apparatus for allocating resources to a node in an ad-hoc network, the apparatus comprising:
a basic frame structure storage unit storing a basic frame structure including a predetermined number of time slots, in which time slots to be used by the node in the ad-hoc network are arranged at predetermined positions;
a start time slot determination unit determining a start time slot among the predetermined number of time slots included in the basic frame structure based on a path sequence number that is a number related to a position of the node on a routing path; and
a communications frame structure determination unit determining a frame structure including the predetermined number of time slots from the start time slot in the basic frame structure that circulates as a communications frame structure for communications of the node.

9. The apparatus of claim 8, wherein the basic frame structure is determined to prevent collisions between the nodes included in the routing path and collisions between the nodes included in the routing path and a node that is not recognized by the node.

10. The apparatus of claim 8, wherein the start time slot determination unit comprises:
a remainder calculation unit calculating a remainder by dividing an ID of the node allocated based on the path sequence number by a frame repetition cycle that is a cycle of nodes having the same communications frame structure on the routing path; and
a start position calculation unit determining an interval between the start time slot and a time slot located at the first position of the basic frame structure based on the obtained remainder and determining the start time slot based on the determined interval.

11. The apparatus of claim 8, wherein the node is a cluster head of a cluster in the ad-hoc network.

12. The apparatus of claim 11, wherein the basic frame structure comprises of at least the time slots each corresponding to a frame for receiving data from a child node in the cluster, a frame for transmitting data to the child node in the cluster, a frame for receiving data from a lower node included in the routing path, a frame for transmitting data to the lower node included in the routing path, a frame for receiving data from an upper node included in the routing path, and a frame for transmitting data to the upper node included in the routing path.

13. The apparatus of claim 8, wherein, when the node has a branch, the node communicates with a node connected via the branch by using a frequency that is different from a frequency used in the routing path.

14. The apparatus of claim 8, wherein the time slots to be used by the node include at least a two lower node time slot pair that are two time slots used in exchanging data with one or more lower nodes included in the routing path and at least a two upper node time slot pair that are two time slots for exchanging data with an upper node included in the routing path, and, when the node is located at a branching point, each of the lower node time slots will be allocated to each branch and, when the branch is a higher path, each of the upper node time slots will be allocated to each branch.
